(19) United States
(12) Patent Application Publication
(10) Pub. No.: US 2010/0290714 A1
(43) Pub. Date: Nov. 18, 2010

(54) Image processing apparatus and image processing method

(75) Inventors: Yuushi Toyoda, Kawasaki (JP); Masayoshi Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/805,298

(22) Filed: Jul. 22, 2010

Related U.S. Application Data
(63) Continuation of application No. PCT/JP08/53271, filed on Feb. 26, 2008.

(51) Int. Cl. G06K 9/40

(52) U.S. Cl. 382/264

(57) ABSTRACT

To compress a dynamic range of an input image based on a relative value indicating a difference between a luminance value indicating a level value of a correction target pixel in the input image and a luminance value indicating a level value of a smoothed pixel obtained by smoothing a neighboring pixel of the correction target pixel, an image processing apparatus generates a reduced image by reducing the input image, generates a smoothed image from the generated reduced image by smoothing the reduced image while keeping an edge portion thereof, generates an enlarged image by enlarging the generated smoothed image to the size of the original input image, and generates an output image by compressing the dynamic range of the input image, based on relative values between the generated enlarged image and the input image.

### CROSS-REFERENCE TO RELATED APPLICATION

This application is a continuation of International Application No. PCT/JP2008/053271, filed on Feb. 26, 2008, the entire contents of which are incorporated herein by reference.

### FIELD

The embodiments discussed herein are directed to an image processing apparatus.

### BACKGROUND

As an image processing method for relatively compressing a dynamic range of an input image, a method for improving image quality called “Center/Surround Retinex” (hereinafter, the “Retinex Method”), which is modeled after characteristics of human visual perception, is conventionally known.

The Retinex Method is a method used for relatively compressing the dynamic range of the entirety of an image by suppressing low frequency components extracted from an input image, while using a Low Pass Filter (LPF) that passes only the low frequency components of the input image (see Japanese National Publication of International Patent Application No. 2000-511315). More specifically, according to Japanese National Publication of International Patent Application No. 2000-511315, it is possible to express a pixel level value O(x,y) of an output image obtained by using the Retinex Method as follows:

O(x,y)=log(I(x,y))−log(LPF(I(x,y)))

where a pixel level value of the input image is expressed as I(x,y), whereas a pixel level value of a low frequency component extracted by the LPF is expressed as (LPF(I(x,y)).

Further, generally speaking, in dynamic range compressing processes performed by using an LPF, it is necessary that the filter size corresponds to an area that is, to a certain extent, large with respect to an input image (e.g., approximately one third of the size of the input image), for the purpose of calculating relative values each indicating a difference in the level values of luminosity between the input image and a smoothed image that are used when the dynamic range is compressed. According to Japanese National Publication of International Patent Application No. 2000-511315 also, because the filter size needs to be approximately one third of the input image, the calculation amount of the LPF is large.

To cope with this situation, Japanese Laid-open Patent Publication No. 2004-165840 discloses a technique with which, by reducing an input image and applying an LPF to the reduced input image, it is possible to realize a dynamic range compressing process that is high speed and is capable of reducing the calculation amount of the LPF.

Let us explain the process described above performed by an image processing apparatus according to Japanese Laid-open Patent Publication No. 2004-165840, with reference to FIG. 9. The image processing apparatus generates a reduced image by performing a reducing process on the input image (see (1) in FIG. 9). Further, the image processing apparatus generates a reduced smoothed image by performing a smoothing process (i.e., applying the LPF) while using the generated reduced image (see (2) in FIG. 9). Subsequently, the image processing apparatus generates an enlarged smoothed image by enlarging the reduced smoothed image that has been generated to the same size as that of the input image (see (3) in FIG. 9). After that, the image processing apparatus generates an output image, based on relative values between the enlarged smoothed image that has been generated and the input image (see (4) in FIG. 9). FIG. 9 is a drawing for explaining the process performed by the conventional image processing apparatus.

According to the conventional techniques described above, however, a problem remains where overshoots and undershoots occur.

More specifically, according to the Retinex Method described in Japanese National Publication of International Patent Application No. 2000-511315, a smoothed pixel value (the low frequency component) is calculated by applying the LPF to a neighboring pixel of a correction target pixel in the input image. According to the Retinex Method, while the smoothed pixel value that has been calculated is brought closer to a mean value of the dynamic range (i.e., while the low frequency component is being suppressed), a relative value (i.e., a high frequency component) between the calculated smoothed pixel value and the correction target pixel value in the input image is enlarged (i.e., the high frequency component is enlarged). Subsequently, according to the Retinex Method, an output image is generated by adding together the suppressed low frequency component and the enlarged high frequency component. As a result, in a high frequency area (e.g., an edge portion) where the luminosity drastically changes, the relative values between the smoothed image and the input image increase in an extreme manner (i.e., overshoots and undershoots occur). Consequently, a problem arises where the image quality of the output image is significantly degraded because the input image is excessively corrected (see FIG. 10).

In the other example, according to Japanese Laid-open Patent Publication No. 2004-165840, although it is possible to perform the process with a smaller calculation amount because the reduced image is used, a problem remains where overshoots and undershoots occur like in the example described in Japanese National Publication of International Patent Application No. 2000-511315, because the edge is not kept in the smoothed image obtained by applying the LPF. FIG. 10 is a drawing for explaining the overshoots and the undershoots that occur when the conventional technique is used.

### SUMMARY

According to an aspect of an embodiment of the invention, an image processing apparatus includes an image reducing processing unit that generates a reduced image by reducing an input image; a first smoothed image generating unit that generates a smoothed image by smoothing the reduced image while keeping an edge portion thereof; an image enlarging processing unit that generates an enlarged image by enlarging the smoothed image to a size of the input image originally input; and an output image generating unit that generates an output image by compressing a dynamic range of the input image, based on a relative value between the enlarged image and the input image.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a drawing for explaining an overview and characteristics of an image processing apparatus according to a first embodiment of the present invention;

FIG. 2 is a block diagram of the image processing apparatus according to the first embodiment;

FIG. 3 is a drawing for explaining overshoots and undershoots that occur according to the first embodiment;

FIG. 4 is a flowchart of a process performed by the image processing apparatus according to the first embodiment;

FIG. 5 is a block diagram of an image processing apparatus according to a second embodiment of the present invention;

FIG. 6 is a drawing for explaining a process to inhibit a jaggy formation according to the second embodiment;

FIG. 7 is a flowchart of a process performed by the image processing apparatus according to the second embodiment;

FIG. 8 is a drawing of a computer that executes image processing computer programs;

FIG. 9 is a drawing for explaining a process performed by a conventional image processing apparatus; and

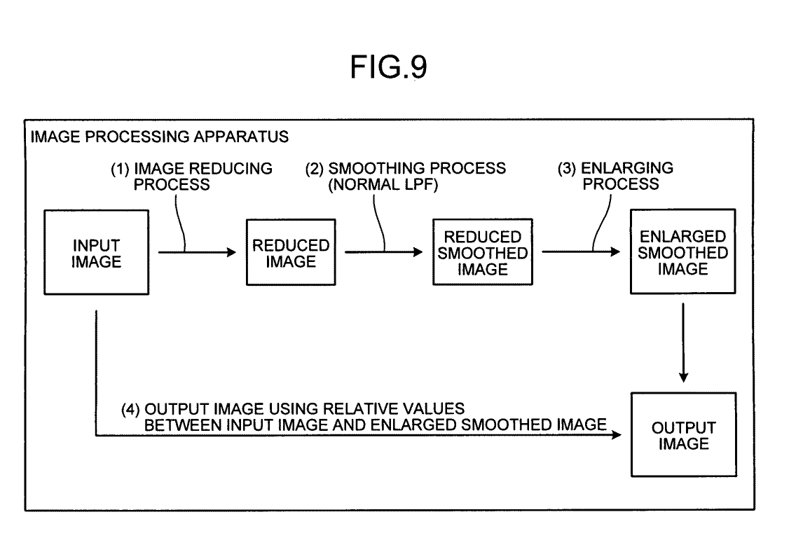

FIG. 10 is a drawing for explaining overshoots and undershoots that occur when a conventional technique is used.

### DESCRIPTION OF EMBODIMENTS

Preferred embodiments of the present invention will be explained with reference to accompanying drawings. In the following sections, an overview and characteristics of an image processing apparatus according to a first embodiment of the present invention as well as a configuration of the image processing apparatus and a flow of a process performed by the image processing apparatus will be sequentially explained, before advantageous effects of the first embodiment are explained.

### [a] First Embodiment

### Overview and Characteristics of Image Processing Apparatus

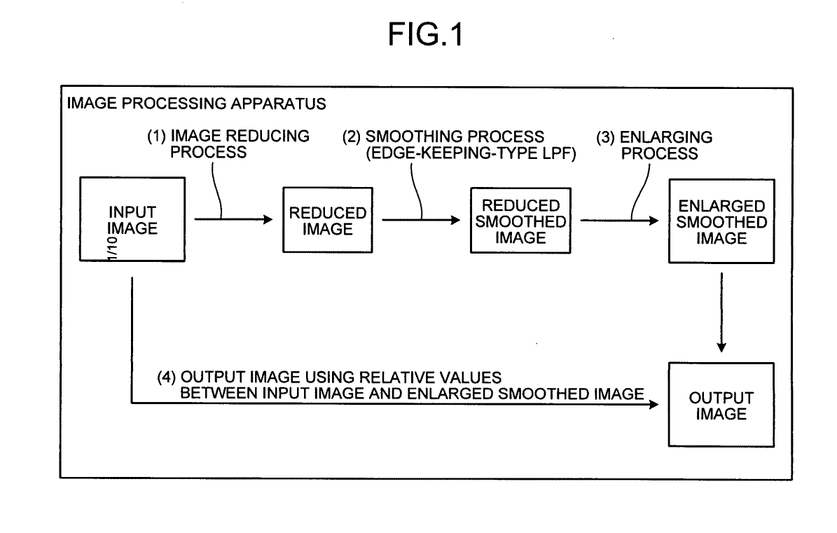

An overview and characteristics of the image processing apparatus according to the first embodiment will be explained. FIG. 1 is a drawing for explaining the overview and the characteristics of the image processing apparatus according to the first embodiment.

The image processing apparatus generates an output image by relatively compressing a dynamic range of an input image by using a relative value between a smoothed pixel obtained by applying an LPF to a neighboring pixel of a correction target pixel in the input image and the correction target pixel.

An overview can be summarized as the image processing apparatus that, in the configuration described above, compresses the dynamic range of the input image. In particular, a principal characteristic of the image processing apparatus is that, when generating the output image by compressing the dynamic range of the input image, the image processing apparatus is able to inhibit overshoots and undershoots in an edge portion of the output image.

Next, the principal characteristic will be further explained. The image processing apparatus generates a reduced image by reducing the input image (see (1) in FIG. 1). To explain this process with a more specific example, when the image processing apparatus has received the input image (e.g., a moving picture or a still picture) that has been input thereto, the image processing apparatus generates the reduced image by performing a process to reduce the input image to a predetermined size. The input image (e.g., the moving picture or the still picture) that is input may be a color image or a monochrome image.

After that, the image processing apparatus generates a smoothed image from the generated reduced image by smoothing the reduced image while keeping an edge portion of the reduced image (see (2) in FIG. 1). To explain this process more specifically with the example used above, the image processing apparatus generates a reduced smoothed image by smoothing the generated reduced image while keeping the edge portion thereof, by applying an edge-keeping-type LPF such as a bilateral filter or an epsilon filter to the generated reduced image. For the purpose of achieving a desirable effect of the dynamic range compressing process by calculating the relative values with a higher degree of precision, it is desirable to use an edge-keeping-type LPF of which the filter size is approximately one third of the height and the width of the reduced image.

Subsequently, the image processing apparatus generates an enlarged image by enlarging the generated smoothed image to the size of the original input image (see (3) in FIG. 1). To explain this process more specifically with the example used above, the image processing apparatus generates an enlarged smoothed image by enlarging the generated smoothed image (i.e., the reduced smoothed image obtained by performing the process to reduce the input image and further performing the process to smooth the reduced input image while keeping the edge portion thereof) to the same resolution level as that of the original input image.

After that, the image processing apparatus generates the output image by compressing the dynamic range of the input image (see (4) in FIG. 1), based on relative values between the generated enlarged image and the input image. To explain this process more specifically with the example used above, the image processing apparatus generates the output image by compressing the dynamic range of the input image, based on the relative values each of which is a difference between a luminance value indicating a level value of luminosity of the generated enlarged image (i.e., the enlarged smoothed image) and a luminance value indicating a level value of luminosity of the input image.

For example, the image processing apparatus calculates a pixel level value for each of all the pixels by

O(x,y)=log(I(x,y))−log(LPF(I(x,y)))

where the pixel level value (i.e., the luminance value) of the input image is expressed as I(x,y), whereas the pixel level value (i.e., the luminance value) of the enlarged smoothed image is expressed as LPF(I(x,y)), while the pixel level value of the output image is expressed as O(x,y).

As explained above, the image processing apparatus according to the first embodiment is capable of generating the reduced smoothed image in which the edge portion is kept, by applying the edge-keeping-type LPF to the input image on which the reducing process has been performed and performing the dynamic range compressing process, based on the relative values between the enlarged smoothed image obtained by enlarging the generated reduced smoothed image to the size of the original input image and the input image. As a result, the image processing apparatus according to the first embodiment is able to inhibit overshoots and undershoots.

Configuration of Image Processing Apparatus

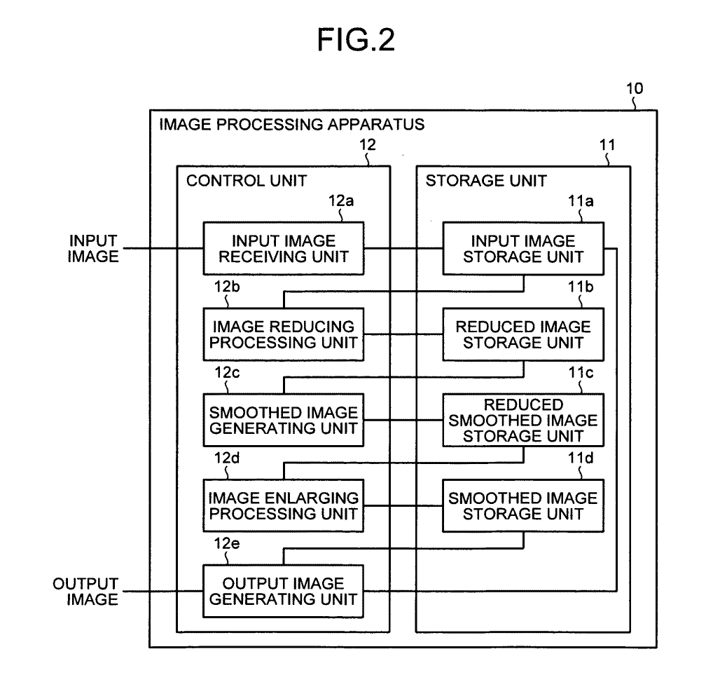

Next, a configuration of the image processing apparatus according to the first embodiment will be explained, with reference to FIG. 2. FIG. 2 is a block diagram of the image processing apparatus according to the first embodiment. As illustrated in FIG. 2, an image processing apparatus 10 includes a storage unit 11 and a control unit 12. The image processing apparatus 10 compresses the dynamic range of the input image, based on the relative values each indicating a difference between the luminance value indicating the level value of the correction target pixel in the input image and the luminance value indicating the level value of the smoothed pixel obtained by smoothing the neighboring pixel of the correction target pixel.

The storage unit 11 stores therein data that is required in various types of processes performed by the control unit 12 and results of the various types of processes performed by the control unit 12. In particular, as constituent elements that are closely related to the present invention, the storage unit 11 includes an input image storage unit 11a, a reduced image storage unit 11b, a reduced smoothed image storage unit 11c, and a smoothed image storage unit 11d.

The input image storage unit 11a stores therein an input image such as a moving picture or a still picture that is input to the image processing apparatus 10 and has been received by an input image receiving unit 12a (explained later). Further, the reduced image storage unit 11b stores therein a reduced image on which a reducing process has been performed by an image reducing processing unit 12b (explained later).

The reduced smoothed image storage unit 11c stores therein a reduced smoothed image that has been smoothed by a smoothed image generating unit 12c (explained later). Further, the smoothed image storage unit 11d stores therein an enlarged smoothed image on which an enlarging process has been performed by an image enlarging processing unit 12d (explained later).

The control unit 12 includes an internal memory for storing therein a control program and other computer programs assuming various types of processing procedures, as well as required data. In particular, as constituent elements that are closely related to the present invention, the control unit 12 includes the input image receiving unit 12a, the image reducing processing unit 12b, the smoothed image generating unit 12c, the image enlarging processing unit 12d, and an output image generating unit 12e and executes various types of processes by using these constituent elements.

The input image receiving unit 12a receives the input image such as a moving picture or a still picture that has been input to the image processing apparatus 10 and stores the received input image into the input image storage unit 11a. To explain this process with a more specific example, the input image receiving unit 12a receives the input image such as a moving picture or a still picture (e.g., a color image or a monochrome image) that has been input to the image processing apparatus 10 and stores the received input image into the input image storage unit 11a. The input image such as a moving picture, a still picture, or the like that is received from an external source may be received not only from an external network, but also from a storage medium such as a Compact Disk Read-Only Memory (CD-ROM).

The image reducing processing unit 12b generates a reduced image by reducing the input image that has been stored in the input image storage unit 11a and stores the generated reduced image into the reduced image storage unit 11b. To explain this process more specifically with the example used above, the image reducing processing unit 12b generates the reduced image by performing a reducing process (i.e., a process to lower the resolution level of the input image) to reduce the input image that has been stored in the input image storage unit 11a to a predetermined size and stores the generated reduced image into the reduced image storage unit 11b.

In normal reducing processes, any algorithm may be used; however, as for an algorithm used in the reducing process performed by the image reducing processing unit 12b, it is preferable to perform a sub-sampling process without interpolating the pixel values in the original input image. Thus, it is desirable to use a “nearest neighbor method” by which the color of the nearest pixel that is positioned adjacent to the target pixel is copied and interpolated (i.e., the original input image is simply reduced).

The smoothed image generating unit 12c generates a smoothed image from the reduced image stored in the reduced image storage unit 11b by smoothing the reduced image while keeping the edge portion thereof and stores the generated smoothed image into the reduced smoothed image storage unit 11c. To explain this process more specifically with the example used above, the smoothed image generating unit 12c generates a reduced smoothed image by smoothing the reduced image while keeping the edge portion thereof, by applying an edge-keeping-type LPF such as a bilateral filter or an epsilon filter to the reduced image that has been stored in the reduced image storage unit 11b and stores the generated smoothed reduced image into the reduced smoothed image storage unit 11c. For the purpose of achieving a desirable effect of the dynamic range compressing process by calculating the relative values with a higher degree of precision, it is desirable to use an edge-keeping-type LPF of which the filter size is approximately one third of the height and the width of the reduced image.

The edge-keeping-type LPF such as a bilateral filter or an epsilon filter is a filter that applies a smaller weight to a focused pixel in the filtering process and to a pixel having a large pixel-value difference from the focused pixel, by combining a weight with respect to a distance difference in a spatial direction and a weight in a pixel level value direction. In other words, the pixel having a large pixel-value difference from the focused pixel in the filtering process corresponds to the edge portion in the image. Thus, by making the weight applied to the edge portion smaller, the smoothed image generating unit 12c generates the smoothed image in which smoothing (i.e., blurring) of the edge portion is inhibited.

The image enlarging processing unit 12d generates an enlarged image by enlarging the smoothed image stored in the reduced smoothed image storage unit 11c to the size of the original input image and stores the generated enlarged image into the smoothed image storage unit 11d. To explain this process more specifically with the example used above, the image enlarging processing unit 12d generates the enlarged smoothed image by enlarging the reduced smoothed image stored in the reduced smoothed image storage unit 11c to the same resolution level as that of the original input image and stores the generated enlarged image into the smoothed image storage unit 11d.

As for an algorithm used in the enlarging process performed by the image enlarging processing unit 12d, it is preferable to inhibit a jaggy formation as much as possible, the jaggy formation being a formation in the shape of steps that is observed near the edge (i.e., an outline portion of the image) when the image is enlarged. Thus, it is desirable to use a bilinear method by which, to create a new pixel, the colors of the four pixels that are positioned adjacent to a target pixel (i.e., the four pixels that are positioned above, below, and to the left and to the right of the target pixel) are simply averaged. In other words, the bilinear method is an image processing method having a high possibility of allowing the output enlarged image to be blurred because the colors are simply averaged. The bilinear method is therefore effective when the image is a coarse image or an image having a possibility of having a jaggy formation (explained above) therein.

The output image generating unit 12e generates the output image by compressing the dynamic range of the input image, based on the relative values between the enlarged image stored in the smoothed image storage unit 11d and the input image stored in the input image storage unit 11a. To explain this process more specifically with the example used above, the output image generating unit 12e generates the output image by compressing the dynamic range of the input image, based on the relative values each of which is a difference between the luminance value indicating the level value of the luminosity of the enlarged image (i.e., the enlarged smoothed image) stored in the smoothed image storage unit 11d and the luminance value indicating the level value of the luminosity of the input image stored in the input image storage unit 11a.

For example, the output image generating unit 12e calculates a pixel level value for each of all the pixels by

O(x,y)=log(I(x,y))−log(LPF(I(x,y)))

where the pixel level value (i.e., the luminance value) of the input image is expressed as I(x,y), whereas the pixel level value (i.e., the luminance value) of the enlarged smoothed image is expressed as LPF(I(x,y)), while the pixel level value of the output image is expressed as O(x,y).

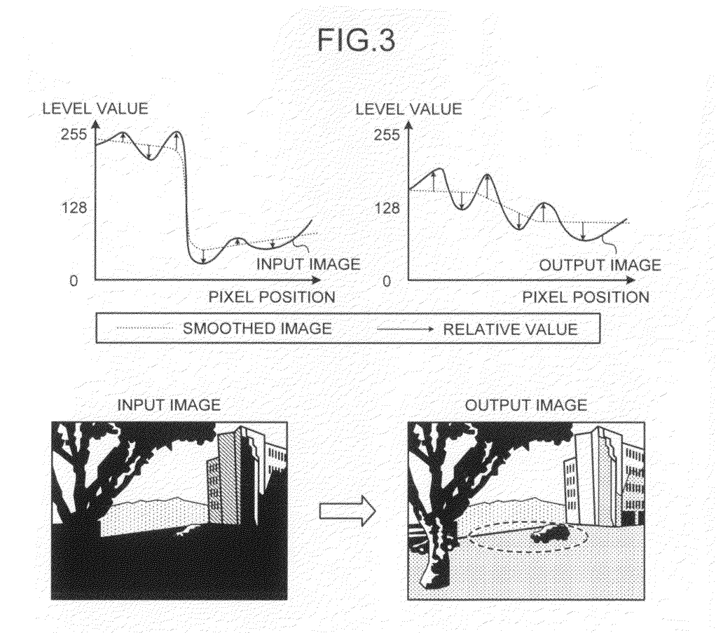

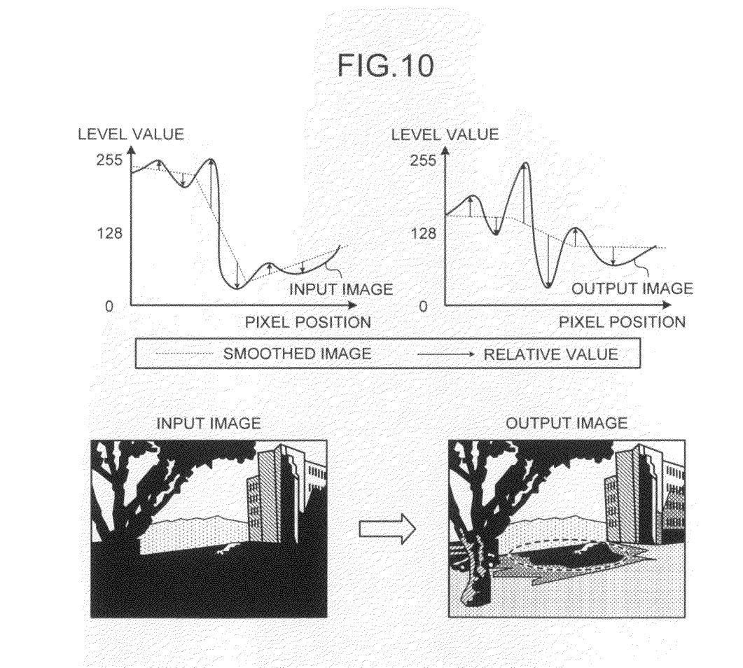

FIG. 3 is a drawing for explaining overshoots and undershoots that occur according to the first embodiment. As illustrated in FIG. 3, the relative values, each of which is a difference between the pixel level value (i.e., the luminance value) of the smoothed image that has been smoothed while the edge portion thereof is kept and the pixel level value (i.e., the luminance value) of the input image, are configured so that, in particular, the relative values in the edge portion are smaller (in other words, more accurate relative values are calculated) than the relative values according to a conventional technique (see FIG. 10) obtained by using a normal LPF that does not keep the edge portion. Consequently, it is possible to generate an output image that has a higher degree of precision, by compressing the dynamic range. As a result, as understood from a comparison between the part marked with the dotted line in the exemplary output image illustrated in FIG. 3 and the part marked with the dotted line in the exemplary output image illustrated in FIG. 10, which is an exemplary output image according to a conventional technique, while overshoots or undershoots have occurred and an unnecessary dark part is observed in the image according to the conventional technique, no unnecessary dark part is observed in the output image according to the first embodiment illustrated in FIG. 3.

Processes Performed by Image Processing Apparatus According to First Embodiment

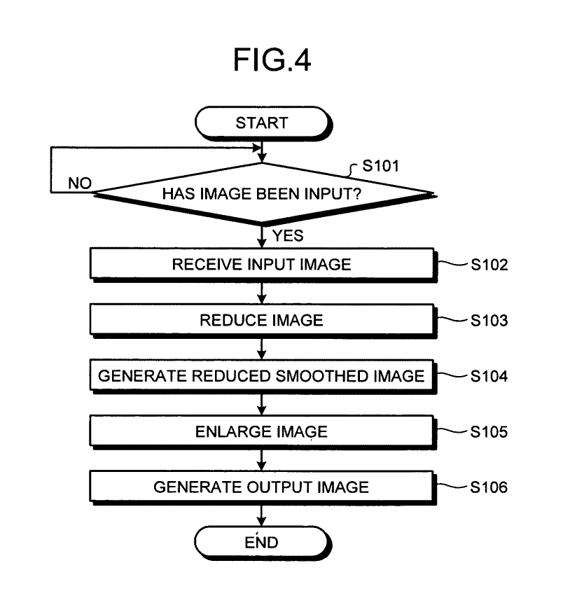

Next, a process performed by the image processing apparatus 10 according to the first embodiment will be explained, with reference to FIG. 4. FIG. 4 is a flowchart of the process performed by the image processing apparatus 10 according to the first embodiment.

As illustrated in FIG. 4, when a moving picture or a still picture has been input to the image processing apparatus 10 (step S101: Yes), the image processing apparatus 10 receives the input image that has been input and stores the input image into the input image storage unit 11a (step S102). After that, the image processing apparatus 10 generates a reduced image by performing the reducing process to reduce the input image stored in the input image storage unit 11a to a predetermined size and stores the generated reduced image into the reduced image storage unit 11b (step S103).

Subsequently, the image processing apparatus 10 generates a reduced smoothed image by smoothing the reduced image while keeping the edge portion thereof, by applying an edge-keeping-type LPF such as a bilateral filter or an epsilon filter to the reduced image that has been stored in the reduced image storage unit 11b and stores the reduced smoothed image that has been generated into the reduced smoothed image storage unit 11c (step S104).

After that, the image processing apparatus 10 generates an enlarged smoothed image by enlarging the reduced smoothed image stored in the reduced smoothed image storage unit 11c to the same resolution level as that of the original input image and stores the generated enlarged smoothed image into the smoothed image storage unit 11d (step S105). Subsequently, the image processing apparatus 10 generates an output image by compressing the dynamic range of the input image, based on the relative values each of which is a difference between the luminance value indicating the level value of the luminosity of the enlarged image (i.e., the enlarged smoothed image) that has been stored in the smoothed image storage unit 11d and the luminance value indicating the level value of the luminosity of the input image that has been stored in the input image storage unit 11a (step S106).

### Advantageous Effects of First Embodiment

As explained above, the image processing apparatus 10 is configured so as to generate the reduced smoothed image in which the edge portion is kept, by applying the edge-keeping-type LPF to the input image on which the reducing process has been performed and to compress the dynamic range based on the relative values between the enlarged smoothed image obtained by enlarging the generated reduced smoothed image to the size of the original input image and the input image. Thus, the image processing apparatus is able to inhibit overshoots and undershoots. In other words, the image processing apparatus 10 is configured so as to reduce the memory as well as to reduce the processing load by reducing the input image. Further, the image processing apparatus is configured so as to inhibit overshoots and undershoots by correcting the range, based on the relative values between the image obtained by smoothing the reduced image while keeping the edge thereof and the input image.

For example, the image processing apparatus 10 receives an input image and stores the input image into the input image storage unit 11a. After that, the image processing apparatus 10 generates a reduced image by performing the reducing process to reduce the input image stored in the input image storage unit 11a to a predetermined size. Subsequently, the image processing apparatus 10 generates a reduced smoothed image by smoothing the reduced image while keeping the edge portion thereof, by applying an edge-keeping-type LPF to the reduced image that has been generated. After that, the image processing apparatus 10 generates an enlarged smoothed image by enlarging the reduced smoothed image that has been generated to the same resolution level as that of the original input image. Subsequently, the image processing apparatus 10 generates an output image by compressing the dynamic range of the input image, based on the relative values each of which is a difference between the luminance value indicating the level value of the luminosity of the enlarged smoothed image that has been generated and the luminance value indicating the level value of the luminosity of the input image that has been stored in the input image storage unit 11a. As a result, the image processing apparatus 10 is able to inhibit overshoots and undershoots. In other words, the image processing apparatus 10 is able to generate an output image having a higher degree of precision by inhibiting overshoots and undershoots.

### [b] Second Embodiment

In the description of the first embodiment above, the example is explained in which the reduced smoothed image obtained by reducing the input image and smoothing the reduced image while keeping the edge thereof is enlarged to the size of the original input image so that the range is corrected based on the relative values between the enlarged image and the input image; however, the present invention is not limited to this example. It is possible to correct the range based on the relative values between an enlarged smoothed image obtained by applying an enlarged image to an LPF and the input image.

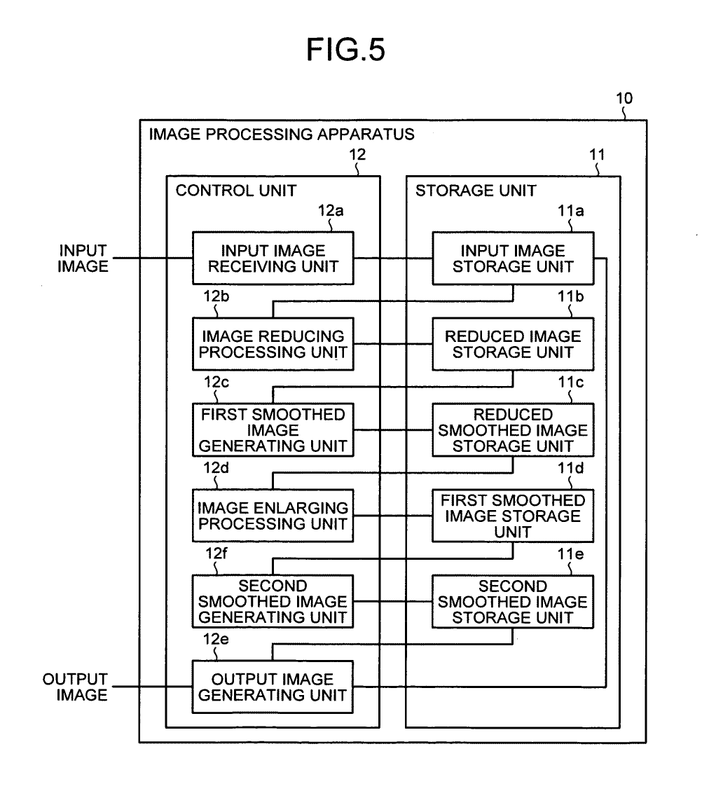

In the description of a second embodiment of the present invention below, a process performed by the image processing apparatus 10 according to the second embodiment will be explained, with reference to FIGS. 5 to 7.

Configuration of Image Processing Apparatus According to Second Embodiment

First, a configuration of the image processing apparatus according to the second embodiment will be explained, with reference to FIG. 5. FIG. 5 is a block diagram of the image processing apparatus according to the second embodiment. In the second embodiment, the smoothed image generating unit 12c explained in the description of the first embodiment will be referred to as a first smoothed image generating unit 12c, whereas the smoothed image storage unit 11d explained in the description of the first embodiment will be referred to as a first smoothed image storage unit 11d. Some the configurations and the functions of the image processing apparatus 10 according to the second embodiment are the same as those according to the first embodiment explained above. Thus, the explanation thereof will be omitted. Accordingly, a smoothing process that is performed after the image enlarging process and is different from the smoothing process according to the first embodiment will be explained in particular.

The storage unit 11 stores therein data that is required in the various types of processes performed by the control unit 12 and the results of the various types of processes performed by the control unit 12. In particular, as constituent elements that are closely related to the present invention, the storage unit 11 includes the input image storage unit 11a, the reduced image storage unit 11b, the reduced smoothed image storage unit 11c, the first smoothed image storage unit 11d, and a second smoothed image storage unit 11e. The second smoothed image storage unit 11e stores therein a smoothed image that has been smoothed by a second smoothed image generating unit 12f (explained later).

The control unit 12 includes an internal memory for storing therein a controlling computer program and other computer programs assuming various types of processing procedures, as well as required data. In particular, as constituent elements that are closely related to the present invention, the control unit 12 includes the input image receiving unit 12a, the image reducing processing unit 12b, the first smoothed image generating unit 12c, the image enlarging processing unit 12d, the second smoothed image generating unit 12f, and the output image generating unit 12e and executes various types of processes by using these constituent elements.

The second smoothed image generating unit 12f generates a smoothed image from the enlarged image stored in the first smoothed image storage unit 11d, by smoothing the enlarged image. To explain this process with a more specific example, the second smoothed image generating unit 12f generates the smoothed image by smoothing the enlarged image that has been generated by the image enlarging processing unit 12d and stored in the first smoothed image storage unit 11d, by using a normal LPF that is not of an edge-keeping type and stores the generated smoothed image into the second smoothed image storage unit 11e. Unlike the first smoothed image generating unit 12c, the normal LPF used by the second smoothed image generating unit 12f does not apply a weight in the pixel value direction, but applies a weight only in the spatial direction. The LPF performs the LPF process by using a filter of which the filter size is approximately the same as the enlargement ratio.

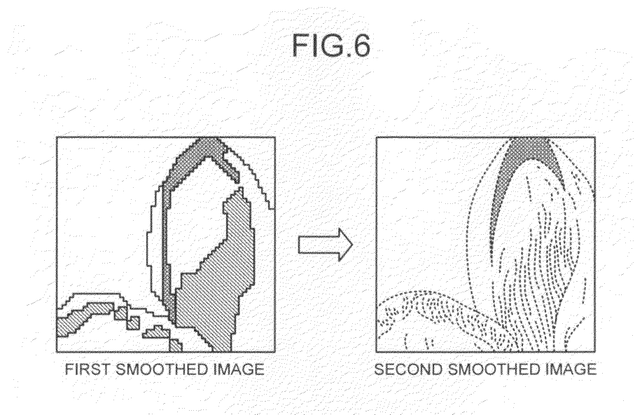

A reason why the second smoothed image generating unit 12f performs the smoothing process by using the normal LPF is that a jaggy formation needs to be inhibited when the image is enlarged, the jaggy formation being a formation in the shape of steps that is observed near the edge (i.e., the outline portion of the image). In other words, as illustrated in FIG. 6, as a result of the smoothing process performed by the second smoothed image generating unit 12f, the jaggy formation observed in the first smoothed image is smoothed so that an image in which the jaggy portion is blurred as shown in the second smoothed image is output. FIG. 6 is a drawing for explaining the process to inhibit the jaggy formation according to the second embodiment.

The output image generating unit 12e generates an output image by compressing the dynamic range of the input image, based on the relative values between the smoothed image stored in the second smoothed image storage unit 11e and the input image stored in the input image storage unit 11a. To explain this process more specifically with the example used above, the output image generating unit 12e generates the output image by compressing the dynamic range of the input image, based on the relative values each of which is a difference between the luminance value indicating the level value of the luminosity of the smoothed image (i.e., the smoothed image that has been smoothed after the enlarging process) stored in the second smoothed image storage unit 11e and the luminance value indicating the level value of the luminosity of the input image stored in the input image storage unit 11a.

Process Performed by Image Processing Apparatus According to Second Embodiment

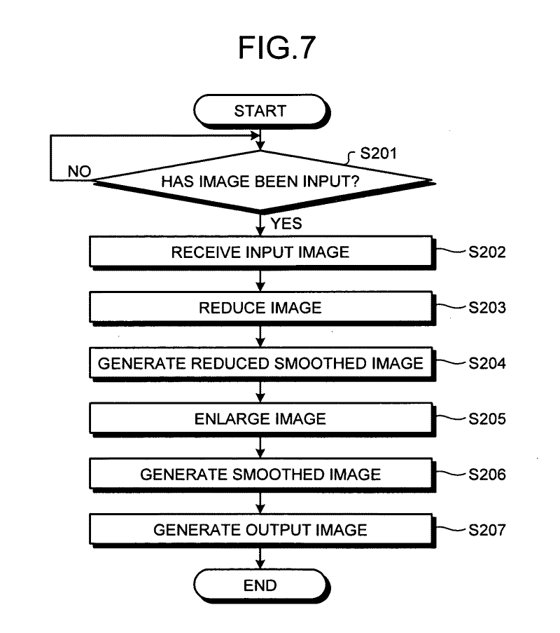

Next, a process performed by the image processing apparatus 10 according to the second embodiment will be explained, with reference to FIG. 7. FIG. 7 is a flowchart of the process performed by the image processing apparatus 10 according to the second embodiment.

As illustrated in FIG. 7, when a moving picture or a still picture has been input to the image processing apparatus 10 (step S201: Yes), the image processing apparatus 10 receives the input image that has been input and stores the input image into the input image storage unit 11a (step S202). After that, the image processing apparatus 10 generates a reduced image by performing the reducing process to reduce the input image stored in the input image storage unit 11a to a predetermined size and stores the generated reduced image into the reduced image storage unit 11b (step S203).

Subsequently, the image processing apparatus 10 generates a reduced smoothed image by smoothing the reduced image while keeping the edge portion thereof, by applying an edge-keeping-type LPF such as a bilateral filter or an epsilon filter to the reduced image that has been stored in the reduced image storage unit lib and stores the reduced smoothed image that has been generated into the reduced smoothed image storage unit 11c (step S204).

After that, the image processing apparatus 10 generates an enlarged smoothed image by enlarging the reduced smoothed image stored in the reduced smoothed image storage unit 11c to the same resolution level as that of the original input image and stores the generated enlarged smoothed image into the first smoothed image storage unit 11d (step S205). Subsequently, the image processing apparatus 10 generates a smoothed image by smoothing the enlarged image stored in the first smoothed image storage unit 11d by using a normal LPF that is not of an edge-keeping type and stores the generated smoothed image into the second smoothed image storage unit 11e (step S206).

Subsequently, the image processing apparatus 10 generates an output image by compressing the dynamic range of the input image, based on the relative values each of which is a difference between the luminance value indicating the level value of luminosity of the smoothed image (i.e., the smoothed image that has been smoothed after the enlarging process) that has been stored in the second smoothed image storage unit 11e and the luminance value indicating the level value of the luminosity of the input image that has been stored in the input image storage unit 11a (step S207).

### Advantageous effects of Second Embodiment

As explained above, the image processing apparatus 10 is configured so as to perform the process to blur the image by applying the normal LPF, which is not of an edge-keeping type, to the smoothed image obtained after the reduced image has been enlarged. Thus, the image processing apparatus 10 is able to inhibit block-shaped jaggy formation near the edge that may be caused by the enlarging process performed on the image. In addition, the image processing apparatus 10 is also able to inhibit overshoots and undershoots.

Further, according to the second embodiment, for the image processing apparatus 10, an LPF having a small filter size that is approximately equivalent to the enlargement ratio used in the image enlarging process is sufficient. Thus, it is possible to generate the output image in which artifacts in the edge portion are inhibited, without degrading the level of the processing performance.

### [c] Other Embodiments

Some exemplary embodiments of the present invention have been explained above; however, it is possible to implement the present invention in various modes other than the exemplary embodiments described above. Thus, some other exemplary embodiments will be explained below, while the exemplary embodiments are divided into the categories of (1) system configurations and (2) computer programs.

(1) System Configurations

Unless otherwise noted particularly, it is possible to arbitrarily modify the processing procedures, the controlling procedures, the specific names, and the information including the various types of data and parameters (e.g., elements that may have a slight difference depending on the LPF being used, such as the processing/controlling procedure performed by the smoothed image generating unit 12c [the edge-keeping-type LPF: an epsilon filter, a bilateral filter, or the like] shown in FIG. 2) that are presented in the text above and in the drawings.

The constituent elements of the apparatuses that are illustrated in the drawings are based on functional concepts. Thus, it is not necessary to physically configure the elements as indicated in the drawings. In other words, the specific mode of distribution and integration of the apparatuses is not limited to the ones illustrated in the drawings. It is acceptable to functionally or physically distribute or integrate all or a part of the apparatuses in any arbitrary units, depending on various loads and the status of use. For example, the output image generating unit 12e may be provided in a distribute manner as a “relative value calculating unit” that calculates the relative values between the input image and the smoothed image and a “dynamic range correcting unit” that generates the output image by compressing the dynamic range of the input image based on the relative values between the input image and the smoothed image. Further, all or an arbitrary part of the processing functions performed by the apparatuses may be realized by a CPU and a computer program that is analyzed and executed by the CPU or may be realized as hardware using wired logic.

(2) Computer Programs

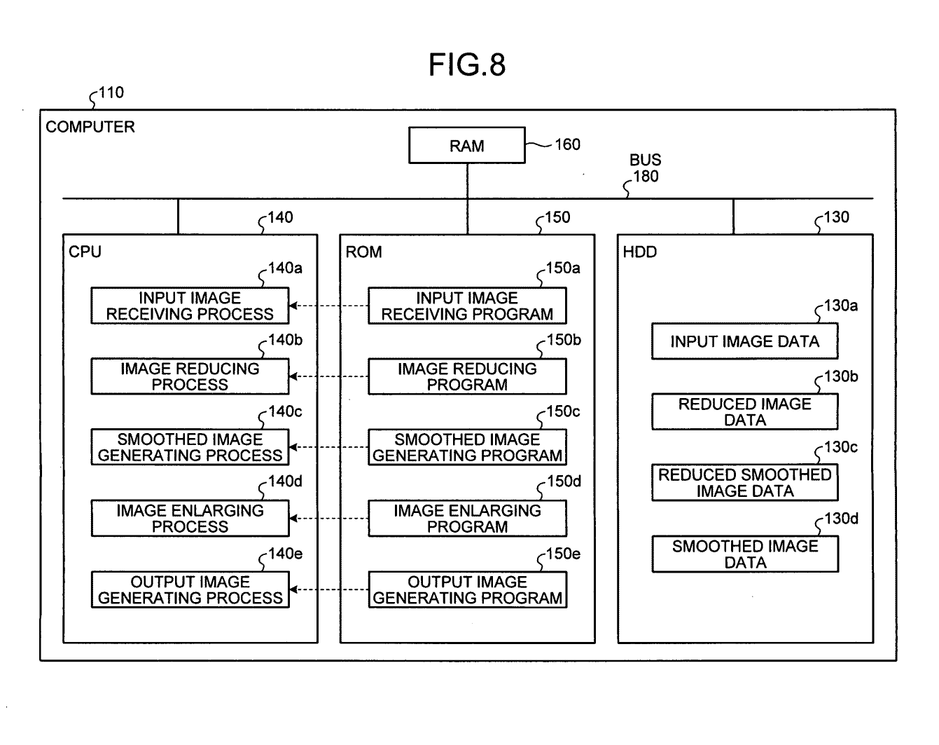

It is possible to realize the image processing apparatus explained in the exemplary embodiments by causing a computer such as a personal computer or a work station to execute a computer program (hereinafter, “program”) prepared in advance. Thus, in the following sections, an example of a computer that executes image programs having the same functions as those of the image processing apparatus explained in the exemplary embodiments will be explained, with reference to FIG. 8. FIG. 8 is a drawing of a computer that executes the image programs.

As illustrated in FIG. 8, a computer 110 serving as an image processing apparatus is configured by connecting a Hard Disk Drive (HDD) 130, a Central Processing Unit (CPU) 140, a Read-Only Memory (ROM) 150, and a Random Access Memory (RAM) 160 to one another via a bus 180 or the like.

The ROM 150 stores therein in advance, as illustrated in FIG. 8, the following image programs that achieve the same functions as those of the image processing apparatus 10 presented in the first embodiment described above: an input image receiving program 150a; an image reducing program 150b; a smoothed image generating program 150c; an image enlarging program 150d; and an output image generating program 150e. Like the constituent elements of the image processing apparatus 10 illustrated in FIG. 2, these programs 150a to 150e may be integrated or distributed as necessary.

Further, when the CPU 140 reads these programs 150a to 150e from the ROM 150 and executes the read programs, the programs 150a to 150e function as an input image receiving process 140a, an image reducing process 140b; a smoothed image generating process 140c; an image enlarging process 140d; and an output image generating process 140e, as illustrated in FIG. 8. The processes 140a to 140e correspond to the input image receiving unit 12a, the image reducing processing unit 12b, the smoothed image generating unit 12c, the image enlarging processing unit 12d, and the output image generating unit 12e that are shown in FIG. 2, respectively.

Further, the CPU 140 executes the image programs based on input image data 130a, reduced image data 130b, reduced smoothed image data 130c, smoothed image data 130d that are recorded in the RAM 160.

The programs 150a and 150e described above do not necessarily have to be stored in the ROM 150 from the beginning. Another arrangement is acceptable in which, for example, those programs are stored in a storage such as any of the following, so that the computer 110 reads the programs from the storage and executes the read programs: a “portable physical medium” to be inserted into the computer 110, such as a flexible disk (FD), a Compact Disk Read-Only Memory (CD-ROM), a Digital Versatile Disk (DVD), a magneto-optical disk, an IC card; a “fixed physical medium” such as an HDD provided on the inside or the outside of the computer 110; “another computer (or a server) that is connected to the computer 110 via a public line, the Internet, a Local Area Network (LAN), or Wide Area Network (WAN).

When the image processing apparatus disclosed as an aspect of the present application is used, it is possible to make smaller the level values of the luminosity of the input image and the enlarged smoothed image obtained by smoothing the reduced image and enlarging the smoothed reduced image to the same size as that of the input image. As a result, an advantageous effect is achieved where it is possible to inhibit overshoots and undershoots.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing apparatus comprising:
an image reducing processing unit that generates a reduced image by reducing an input image;
a first smoothed image generating unit that generates a smoothed image by smoothing the reduced image while keeping an edge portion thereof;
an image enlarging processing unit that generates an enlarged image by enlarging the smoothed image to a size of the input image originally input; and
an output image generating unit that generates an output image by compressing a dynamic range of the input image, based on a relative value between the enlarged image and the input image.

2. The image processing apparatus according to claim 1, further comprising a second smoothed image generating unit that generates a smoothed image by smoothing the enlarged image, wherein
the output image generating unit generates the output image by compressing the dynamic range of the input image, based on a relative value between the smoothed image generated by the second smoothed image generating unit and the input image.

3. An image processing method comprising:
generating a reduced image by reducing an input image;
generating a smoothed image by smoothing the reduced image while keeping an edge portion thereof;
generating an enlarged image by enlarging the smoothed image to a size of the input image originally input; and
generating an output image by compressing a dynamic range of the input image, based on a relative value between the enlarged image and the input image.

4. A computer readable storage medium having stored therein an image processing program causing a computer to execute a process comprising:
generating a reduced image by reducing an input image;
generating a smoothed image by smoothing the reduced image while keeping an edge portion thereof;
generating an enlarged image by enlarging the smoothed image to a size of the input image originally input; and
generating an output image by compressing a dynamic range of the input image, based on a relative value between the enlarged image and the input image.
